(19) United States
(12) Patent Application Publication
(10) Pub. No.: US 2004/0140911 A1
(43) Pub. Date: Jul. 22, 2004

(54) Warning device

(76) Inventor: Jen-Fu Chen, Feng Yuan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/346,943

(22) Filed: Jan. 17, 2003

(51) Int. Cl. G08G 1/095

(52) U.S. Cl. 340/908

(57) ABSTRACT

A multi-purpose warning device includes a cylinder for receiving at least one battery, a bracket mounted on the cylinder, a flashlight head pivotally mounted on the bracket, a socket movably mounted on the cylinder between a first position where the flashlight head is at least partially received therein and the bracket is received therein, three legs each including a first end pivotally connected with the socket and a second end pivotally connected with the cylinder so that they can be closed so as to form a cylindrical handle and opened in order to act as legs, and three connectors each connected between two of the legs. The socket includes an enlarged portion for receiving a portion of the flashlight head. Each of the connectors is a toggle.

### BACKGROUND OF INVENTION

1. Field of Invention

The present invention relates to a warning device.

2. Related Prior Art

U.S. Pat. No. 5,684,452 discloses a multi-purpose warning device including a battery container 10, a first cap 12, a tube 20, a bracket 30, a flashlight head 32, a socket 40, three feet 50, three sticks 60 and a second cap 70. The battery container 10 is used to contain at least one battery. The first cap 12 can be engaged with the battery container 10 in order to keep the at least one battery in the battery container 10. The tube 20 is mounted on the battery container 10. A light bulb 21 is received in the tube 20. The bracket 30 is rotationally mounted on the tube 20. The flashlight head 32 is pivotally mounted on the bracket 30. A light bulb is received in the flashlight head 32. The socket 40 is movably mounted on the battery container 10 and the tube 20. Each of the feet 50 is pivotally connected with the socket 40. Each of the sticks 60 includes an end pivotally connected with one of the feet 50 and an opposite end pivotally connected with the battery container 10. The feet 50 can be closed and engaged with the second cap 70, thus forming a cylindrical handle to be held by a hand of a user such as a policeman. In an application, the light bulb received in the flashlight head 32 is turned on so that the warning device is used as a flashlight. In a second application, the light bulb 21 is turned on so that the warning device is used as a baton. In a third application, the second cap 70 is removed from the feet 50, and the feet 50 are opened. Thus, the warning device can be installed on the ground. In the first and second applications, the flashlight head 32 tends to pivot on the bracket 30, and this is not desired. In the third application, the feet 50 tend to shake since there is no interconnection between them.

The present invention is therefore intended to obviate or at least alleviate the problems encountered in prior art.

### SUMMARY OF INVENTION

It is an objective of the present invention to provide a multi-purpose warning device with a pivotal flashlight head that is kept in position when the multi-purpose warning device is used as a flashlight.

It is another objective of the present invention to provide a multi-purpose warning device with three pivotal feet that can be held stably in an open position.

According to the present invention, a multi-purpose warning device includes a cylinder for receiving at least one battery, a bracket mounted on the cylinder, a flashlight head pivotally mounted on the bracket, a socket movably mounted on the cylinder between a first position where the flashlight head is at least partially received therein and the bracket is received therein, three legs each including a first end pivotally connected with the socket and a second end pivotally connected with the cylinder so that they can be closed so as to form a cylindrical handle and opened in order to act as legs, and three connectors each connected between two of the legs.

The socket may include an enlarged portion in order to receive a portion of the flashlight head.

Each of the connectors may be a toggle.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is an exploded view of a multi-purpose warning device according to the present invention.

FIG. 2 is a cutaway of the multi-purpose warning device shown in FIG. 1.

FIG. 3 is a perspective view of the multi-purpose warning device shown in FIG. 2.

FIG. 4 is a side view of the multi-purpose warning device shown in FIG. 3 on the way to an open position.

FIG. 5 is a side view of the multi-purpose warning device shown in FIG. 4 in the open position.

### DETAILED DESCRIPTION OF PREFERRED EMBODIMENT

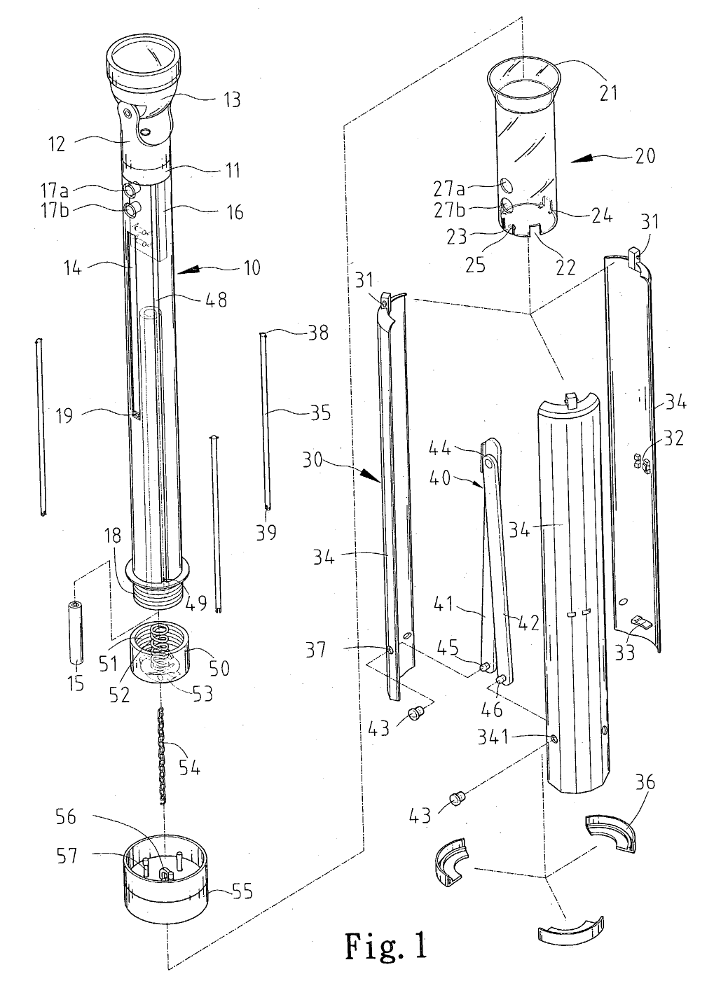

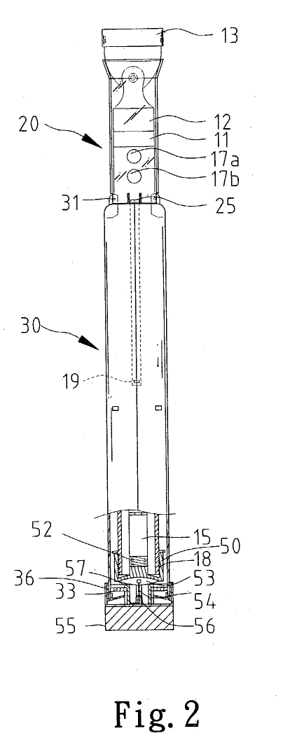

Referring to FIGS. 1 and 2, according to the preferred embodiment of the present invention, a multi-purpose warning device includes a cylinder 10, a bracket 12, a flashlight head 13, a socket 20, three legs 30 and three connectors 40.

The cylinder 10 is hollow in order to contain elements to be described. A first cap 11 is secured to a first end of the cylinder 10. A second cap 50 can be engaged with a second end of the cylinder 10 in a manner to be described. A bracket 12 is rotationally mounted on the first cap 11. The flashlight head 13 is pivotally mounted on the bracket 12. A bulb (not shown) is received in the flashlight head 13, and a bulb (not shown) is received in the cylinder 10. A circuit board 16 is received in the cylinder 10 for electric connection with both of the bulbs. A first switch 17a and a second switch 17b are in electric connection with the circuit board 16. The switches 17a and 17b are exposed to the exterior of the cylinder 10 through two holes (not numbered) defined in the cylinder 10. The switches 17a and 17b can be in the form of a button. The first switch 17a is used to turn on and off the bulb in the flashlight head 13, and the second switch 17b the bulb in the cylinder 10. Obviously, the cylinder 10 must be transparent or at least translucent. At least one battery 15 can be received in the cylinder 10 for electric connection with the circuit board 16. A thread 18 is formed on an external face of the cylinder 10 at the second end for engagement with a thread 51 formed on an internal face of the second cap 50. A groove 14 is defined in the external face of the cylinder. The groove 14 includes a first closed end and a second closed end. A ridge 19 is formed on the bottom of the groove 14 near the second closed end.

The socket 20 is movably mounted on the cylinder 10. The socket 20 is transparent or at least translucent so that light emitted from the bulb in the cylinder 10 can pass through the socket 20. The socket 20 includes an enlarged portion 21 formed at a first end thereof and three cutouts 22 defined in a second end thereof. Each of the cutouts 22 is located between two lugs 24 formed on the internal face of the socket 20. The socket 20 includes a tab 23 formed via cutting two slits (not numbered) in the second end thereof. A ridge 25 is formed on an internal face of the tab 23. The ridge 25 is allowed to slide in the groove 19 between the first and second closed ends when the socket 20 is mounted on the cylinder 10. The socket 20 defines a first hole 27a corresponding to the first switch 17a and a second hole 27b corresponding to the second switch 17b.

Each of the legs 30 includes a pair of axles 31 formed on a first end thereof, two holes 37 defined therein near a second end thereof, two lugs 32 formed on an internal face thereof and a tab 33 formed on the internal face thereof. The pair of axles 31 of each of the legs 30 is engaged with each of the pairs of lugs 221 so that each of the legs 30 is pivotally connected with the socket 20. A pad 36 is attached to the second end of each of the legs 30. The legs 30 may be made of a reflective material for reflecting light shun thereon. Alternatively, the external face of each of the legs 30 can be covered with a layer of a reflective material or a reflective sticker.

Three ribs 35 can be connected between the cylinder 10 and the legs 30. Three grooves 48 are defined in the external face of the cylinder 10 for receiving the ribs 35 in the shown embodiment; however, a groove may be defined in the internal face of each of the legs 30 for receiving one of the ribs 35 in another embodiment. Three pairs of lugs 49 are formed on the external face of the cylinder 10. Each of the ribs 35 includes two axles 38 formed at a first end thereof for engagement with the lugs 32 formed on one of the legs 30 and two axles 39 formed at a second end thereof for engagement with one of the pairs of lugs 49 formed on the external face of the cylinder 10.

Each of the connectors 40 is connected between two of the legs 30. Each of the connectors 40 is a toggle in the shown embodiment and may, however, be a flexible element such as a cable and a chain in another embodiment. Each of the toggles 40 consists of a first link 41 and a second link 42 pivotally connected with the first link 41. A limit 44 is formed on the first link 41 for engagement with the second link 42 when they are opened. The first link 41 includes a pin 45 inserted through one of the holes 37 defined in one of the legs 31 into engagement with a cap 43. The second link 42 includes a pin 46 inserted through one of the holes 37 defined in another one of the legs 31 into engagement with a cap 43.

A spring 52 is secured to the internal face of the second cap 50 in order to bring the at least one battery 15 into firm contact with the circuit board 16. The second cap 50 is connected with a third cap 55 through a chain 54. The chain 54 includes a first end hooked on a hook 53 formed on the second cap 50 and a second end hooked on a hook 56 formed on the third cap 55. Three rods 57 project from the third cap 55. Each of the rods 57 includes an enlarged head for engagement with one of the tabs 33.

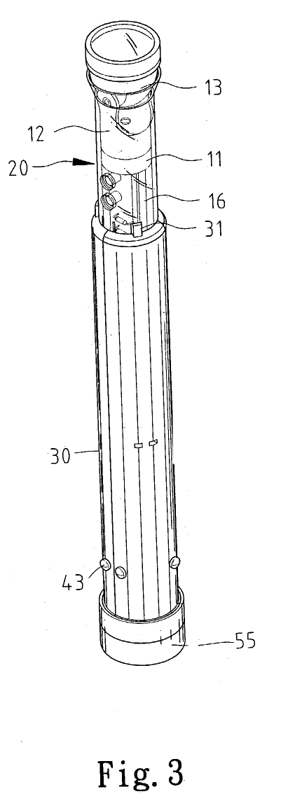

Referring to FIG. 3, the legs 30 are closed, thus forming a cylindrical handle to be held by a hand of a user such as a policeman. The second ends of the legs 30 are inserted in the third cap 55. The third cap 55 is rotated relative to the second ends of the legs 30 in order to engage the enlarged heads of the rods 57 with the tabs 33, thus keeping the legs 30 in the closed position. The bracket 12 is in the socket 20 and the flashlight head 13 the enlarged portion 21. Thus, the flashlight head 13 is kept in position relative to the bracket 12. In an application, the light bulb in the flashlight head 13 is turned on so that the warning device is used as a flashlight. In a second application, the light bulb in batter-container 10 is turned on so that the warning device is used as a baton.

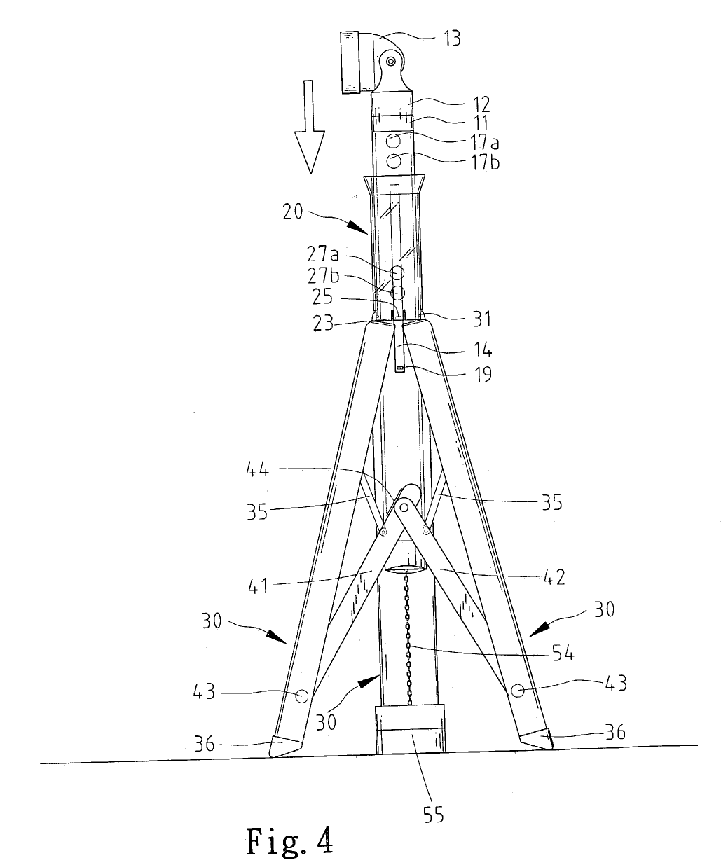

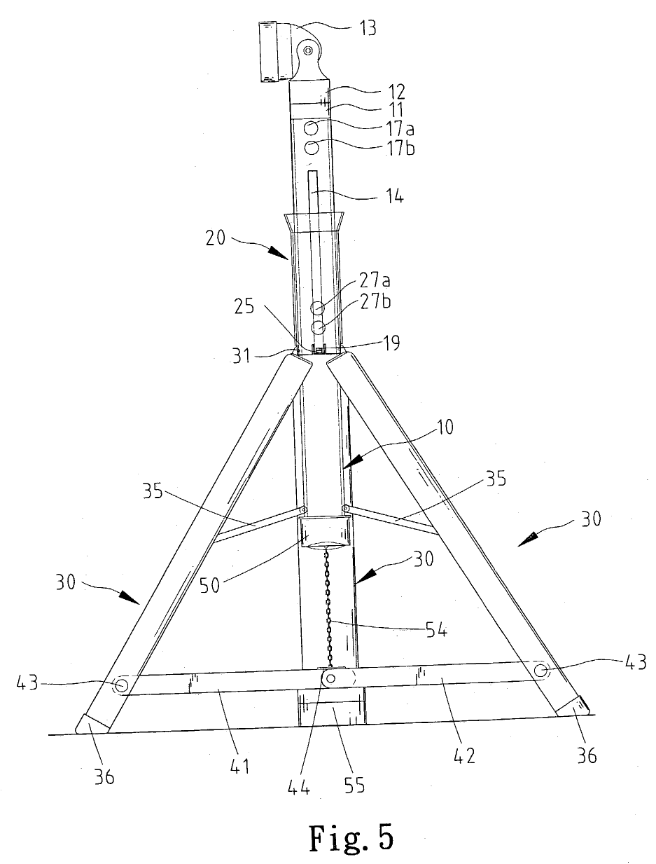

Referring to FIGS. 4 and 5, in a third application, the legs 30 are opened. Thus, the warning device can be installed on the ground. The ridge 25 is trapped between the second closed end of the groove 14 and the ridge 19. Thus, the legs 30 are kept in the open position. The legs 30 are held stably in the open position because of the connectors 40 and the ribs 35.

The present invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

What is claimed is:

1. A warning device including:
a cylinder for receiving at least one battery;
a bracket mounted on the cylinder;
a flashlight head pivotally mounted on the bracket;
a socket movably mounted on the cylinder between a first position where the flashlight head is at least partially received therein and the bracket is received therein;
three legs each including a first end pivotally connected with the socket and a second end pivotally connected with the cylinder so that they can be closed so as to form a cylindrical handle and opened in order to act as legs; and
three ribs each including a first end pivotally connected with the cylinder and a second end pivotally connected with one of the legs.

2. The warning device according to claim 1 wherein the socket includes an enlarged portion for receiving a portion of the flashlight head.

3. The warning device according to claim 1 including a switch mounted on the cylinder and electrically connected with a bulb received in the flashlight head, and the socket defines a hole in order to receive the switch.

4. The warning device according to claim 1 wherein the cylinder defines a groove in an external face thereof, and the socket includes a ridge formed on an internal face thereof for sliding in the groove.

5. The warning device according to claim 4 wherein the groove is defined between a first closed end and a second closed end, and the cylinder includes a ridge formed on a bottom of the groove near the second closed end of the groove, and the ridge of the socket can be trapped between the ridge of the cylinder and the second closed end of the groove.

6. The warning device according to claim 1 wherein the cylinder defines three grooves in an external face thereof for receiving the ribs.

7. A multi-purpose warning device including:
a cylinder for receiving at least one battery;
a bracket mounted on the cylinder;
a flashlight head pivotally mounted on the bracket;
a socket movably mounted on the cylinder;
three legs each including a first end pivotally connected with the socket and a second end pivotally connected with the cylinder so that they can be closed so as to form a cylindrical handle and opened in order to act as legs; and
three connectors each connected between two of the legs.

8. The multi-purpose warning device according to claim 7 wherein each of the connectors is a toggle.

9. The multi-purpose warning device according to claim wherein each of the connectors includes a first link and a second link pivotally connected with the first link.

10. The multi-purpose warning device according to claim 9 wherein the first link includes a tab formed thereon for engagement with the second link.

11. The multi-purpose warning device according to claim 7 including a switch mounted on the cylinder and electrically connected with a bulb received in the flashlight head, and the socket defines a hole in order to receive the switch.

12. The multi-purpose warning device according to claim 7 wherein the cylinder defines three grooves in an external face thereof for receiving the ribs.

13. The multi-purpose warning device according to claim 7 wherein the cylinder defines a groove in an external face thereof, and the socket includes a ridge formed on an internal face thereof for sliding in the groove.

14. The multi-purpose warning device according to claim 10 wherein the groove is defined between a first closed end and a second closed end, and the cylinder includes a ridge formed on a bottom of the groove near the second closed end of the groove, and the ridge of the socket can be trapped between the ridge of the cylinder and the second closed end of the groove.

15. A warning device including:
a cylinder for receiving at least one battery;
a bracket mounted on the cylinder;
a flashlight head pivotally mounted on the bracket;
a socket movably mounted on the cylinder between a first position where the flashlight head is at least partially received therein and the bracket is received therein,
three legs each including a first end pivotally connected with the socket and a second end pivotally connected with the cylinder so that they can be closed so as to form a cylindrical handle and opened in order to act as legs; and
three connectors each connected between two of the legs.

16. The warning device according to claim 15 wherein the socket includes an enlarged portion for receiving a portion of the flashlight head.

17. The warning device according to claim 15 including a switch mounted on the cylinder and electrically connected with a bulb received in the flashlight head, and the socket defines a hole in order to receive the switch.

18. The warning device according to claim 15 wherein the cylinder defines a groove in an external face thereof, and the socket includes a ridge formed on an internal face thereof for sliding in the groove.

19. The warning device according to claim 18 wherein the groove is defined between a first closed end and a second closed end, and the cylinder includes a ridge formed on a bottom of the groove near the second closed end of the groove, and the ridge of the socket can be trapped between the ridge of the cylinder and the second closed end of the groove.

20. The multi-purpose warning device according to claim 15 wherein each of the connectors is a toggle.
